(19) United States
(12) Patent Application Publication
(10) Pub. No.: US 2012/0278033 A1
(43) Pub. Date: Nov. 1, 2012

(54) METHOD FOR THE DETERMINATION OF AN ABSOLUTE POSITION ANGLE OF A CAPACITIVE MOTION ENCODER

(75) Inventors: Johann Bücher, Aldingen (DE); Siegfried Held, Donaueschingen (DE)

(73) Assignee: HENGSTLER GMBH, Aldingen (DE)

(21) Appl. No.: 13/512,758

(22) PCT Filed: Dec. 3, 2010
(86) PCT No.: PCT/EP2010/007337

§ 371 Date: Jul. 5, 2012

(30) Foreign Application Priority Data
Dec. 4, 2009 (EP) 09015054.1

(51) Int. Cl. G01D 5/241; G06F 19/00

(52) U.S. Cl. 702/151

(57) ABSTRACT

Method for the determination of the position angle of a capacitive motion encoder (1) for sensing the position of a rotor (6) relative to a stator (2, 37) comprising an eccentric rotor disk (6, 7) relatively movable to a stationary stator (2, 37) with four electrical isolated field transmitters (4a, 4b, 4c, 4d; 38a-d) which generate an electrostatic field in a receiver area (5) which is modulated by a change in capacitance between the stator (2, 37) and rotor disk (6, 7) response to relative motion of the elements; and a processing circuitry (49) coupled to sense the modulated electrostatical field and determine responsive thereto a measure of the position of a moving object, characterized in that within one cyclic measurement time (10) at least 8 measurements (11 through 18) are carried out defining at least 8 different capacitance values (C1, C2, C3, C4, C4′, C3′, C2′, C1′) where the first capacitor C1 is measured in the 1st and 8th cycle, the second capacitor C2 is measured in the 2nd and 7th cycle, the third capacitor C3 is measured in the 3rd and 6th cycle, and the fourth capacitor C4 is measured in the 4th and 5th cycle.

The invention refers to a capacitive motion encoder and a method for the operation of a measuring circuit as well as to a method for the determination of an absolute angle of rotation of said capacitive motion encoder.

For example, such motion encoder has become known by the subject matter of DE 600 16 395 C2. In accordance with FIG. 2 of this printed patent specification a quadrantal measuring is carried out as well. Four quadrantal fields separated from each other are defined on a stator which are sweeped over by an eccentric rotor. A corresponding capacitance is captured from each quadrantal field and processed in a measuring circuit.

Therefore, the invention is based on the problem to further develop a capacitive motion encoder in accordance with DE 600 16 395 C2 (EP 1,173,730 B1) as such that a much more accurate capture of the capacitance is given.

To solve the problem set the invention is characterized by the technical teaching included in claim 1.

The essential feature of the invention is that, in the area of the total measuring cycle which may, for example, last for a period of 10 to 100 μs, a series of cyclical successive measurements is carried out, where, within a time of measurement which may, for example, be in the range of 2 μs to 20 μs, the capacitance of the corresponding quadrant is interrogated successively and that, in addition and in the course of the total measuring cycle and following the interrogation of the last capacitance (fourth capacitance), this fourth capacitance is interrogated again and the third capacitance is interrogated again then and the second capacitance is interrogated then and the first capacitance is interrogated again and that all 8 measurements form the entire measuring cycle and that, in addition and for the evaluation of those 8 measuring values measured as such, the first capacitance value measured at the beginning and at the end of the measuring cycle are brought into relationship with each other, then the second capacitance value interrogated in the second place and the last but one capacitance value are also brought into relationship with each other and that, in addition, capacitance value C3 interrogated in the third place is also brought into relationship with the last but two capacitance value interrogated and that, in addition, capacitance value C4 interrogated in the fourth place is brought into relationship with the last but three capacitance value interrogated.

Therefore, with the technical teaching given an entire measuring cycle is defined comprising 8 individual measurements, where each quadrant makes one measuring value available only so that there are 4 measuring values existing only which, however, are measured twice.

With the given technical teaching there is a much more better capture of capacitance per total measuring cycle because a total of 8 measuring values are resulting thereof taken from 4 quadrants.

The figures defined herein (4 quadrants and 8 measurements) are to be understood as an example only and do not limit the scope of protection of the present invention. For example, there may also be 3 or 5 or 6 quadrants existing only.

If there are three quadrants existing 6 individual measurements are carried out by applying the technical teaching of the invention, and if there are 5 quadrants existing 10 measurements are carried out.

Then these measuring values are also connected combinatorially in the same way in accordance with the processing principle defined below. However, the invention is not limited to this as is mentioned above.

In a preferred additional development of the present invention it is provided that the mutual accounting of the corresponding individual capacitances of those 4 quadrants (C1 to C1′ or C2 to C2′ or C3 to C3′ or C4 to C4′) is carried out as such that a mean value is formed from both measuring values C1, C1′, i.e. C1M and a differential value, i.e. C1 DIFF.

The same teaching applies also to those other capacitance values so that, for example, mean value C2M and differential value C2DIFF are formed out of capacitance value C2.

With this technical teaching an essential advantage is achieved compared with the prior art because it is possible for the first time to read out and further process relatively small measurement values in finest resolution.

The formulae defined below always include factor 3.5. This factor results from the fact that, in the course of the measuring cycle, the distance between capacitance C1 and the virtual mean measuring point is exactly 3.5 periods and for this reason factor 3.5 is existing.

The virtual time of measurement is put in the middle between those 8 capacitance values measured, i.e. there are 4 measurements before and 4 measurements after the virtual time of measurement. The virtual time of measurement is defined after 8 successive measurements made only.

Based on the double interrogation of each individual capacitance (of a total of 4 capacitances) at different periods of time there are much more accurate computational methods resulting which are described in detail below.

Those computational methods described below are to be understood as the essence of the invention and the method to determine individual capacitance values and an entire capacitance as well as determine the angle of rotation of the rotor to the stator is claimed as being an essence of the invention.

### Equations for Single Measurements C₁, C₂, C₃, C₄, C₅, C₆, C₇, and C₈

The following denotations apply to additional calculations:

θ₀—initial value of angle at the beginning of the measurement,

C₀ᵢ—nominal value (i.e. offset) for each quadrant, i=1,2,3,4

ΔCᵢ—maximum amplitude variation for each quadrant,

ω—radial speed of sensor

T_{cycle}—duration of 1 cycle

Like the results of measurement those 8 values given can be presented with the following 8 equations (1) through (8):

C₁=C₀₁+ΔC₁*sin(θ_{0F}), (1)

C₂=C₀₂+ΔC₂*cos(θ_{0F}+ωT_{cycle}) (2)

C₃=C₀₃−ΔC₃*sin(θ_{0F}+2ωT_{cycle}) (3)

C₄=C₀₄−ΔC₄*cos(θ_{0F}+3ωT_{cycle}) (4)

C₄′=C₀₄−ΔC₄*cos(θ_{0F}+4ωT_{cycle}) (5)

C₃′=C₀₃−ΔC₃*sin(θ_{0F}+5ωT_{cycle}) (6)

C₂′=C₀₂ ΔC₂*cos(θ_{0F}+6ωT_{cycle}) (7)

C₁′=C₀₁+ΔC₁*sin(θ_{0F}+7ωT_{cycle}) (8)

On the basis of the first 8 equations (1) through (8) differential values between the appropriate are calculated:

### Equations for Approximated Mean Values of Single Measurements C₁^{m}, C₂^{m}, C₃^{m} and C₄^{m}

Based on the previous equations defined their mean values are calculated in the following way:

C1m=(C1+C1′)/2 (9)

Based on 8 measurement values there are 4 sampled points being valid. Two pairs of them are taken from diagonal quadrants, i.e. capacitances C₁^{m} and C₃^{m} are one pair, capacitances C₂^{m} and C₄^{m} are the second pair.

### Equations for Approximated Differential Values of Single Measurements C₁^{diff}, C₂^{diff}, C₃^{diff} and C₄^{diff}

On the basis of the first 8 equations (1) through (8) differential values between the appropriate are calculated as follows:

C1diff=(C1−C1′)/2 (13)

Finding the Ratio Between Amplitude Variations in Opposite (Diagonal) Quadrants r1 and r2

Based on equations (17) through (20) the ratio between amplitude variations existing in opposite quadrants can be calculated. The ratio between differential values in the first and third quadrant is denoted with b, and is denoted with a between the second and fourth.

[symbol]

(24)

If the sensor is without wobble influence all 4 quadrants have the same offset value and asymmetry in the positive and negative part of the sinusoid is present only. It makes sense that in the positive part of the capacitance signal the maximum amplitude variation ΔC₊ is different from that existing in the negative part ΔC.

Wobble influence means that the area of the rotor plate is not parallel to the area of the stator plate.

### Scaled Values of C₁^{m} and C₂^{m}

Under the influence of wobble and some parasitic effects all 4 sinusoids (from all 4 quadrants) are not with the same nominal value and not with the same amplitude variations. The values measured from the first quadrant are scaled with the value of 7/3b. Now they are brought into the same boundaries as the values from the third quadrant already are. Their offsets have also to be the same. This approximation is used for their offset calculations. The same is valid for scaled value C2m′ and C4m.

Amplitude variations from scaled values C₁^{m} and C₃^{m} are the same. Their offsets have to be equal, too. This approximation is used for their offset calculations. The same is valid for scaled values C₂^{m} and C₄^{m}.

Finding the Position Angle Without Value x (x=ωTcycle) Calculation

The value of angle is given with:

Φ=arctg[sqrt(3*abs(C₃₀^{m}/C₄₀^{m})*abs(C₄^{diff}/C₃^{diff}))], (64a)

Φ=arctg[sqrt(7/5*abs(C₁₀^{m}/C₂₀^{m})*abs(C₂^{diff}/C₁^{diff}))], (64b)

and for algorism applications it is:

Φ=abs(Φ) (65)

### Finding the Quadrant and Final Position Angle

According to the signs of values C₁₀^{m} and C₂₀^{m} the quadrant of our position can be obtained:

C₁₀^{m}>0,C₂₀^{m}>0:quadrant I, i.e. Φ_{final}=Φt (65a)

C₁₀^{m}>0,C₂₀^{m}<0:quadrant II, i.e. Φ_{final}=π−t (65b)

C₁₀^{m}<0,C₂₀^{m}<0:quadrant III, i.e. Φ_{final}=π+Φt (65c)

C₁₀^{m}<0,C₂₀^{m}>0:quadrant IV, i.e. Φ_{final}=2π−Φt (65d)

Together with finding the quadrant and the approximated value of angle φ (equation 65) the position of the sensor is known.

The position estimation algorism—fine trace applications

The development of the previous position estimation algorism is based on approximations of sin(x) with only one-term of Taylor series for the small value of x. For the fine trace this approximation for the greater values of M is not valid because the x value is M times greater.

For the fine trace equations (1) through (8) are defined on the next manner, where M is the number of poles in fine trace. Its value is usually 8, 16, 32, i.e. the power of 2.

It is the aim to estimate the position angle from 8 basic measurements, for each quadrant there are 2 measurements. In ideal circumstances all 4 capacitors measured have the same nominal and amplitude variation values. As a matter of fact these values are not the same.

One possibility is that all 4 quadrants have the same nominal and amplitude variation values, but with asymmetry in the positive and negative part of the sinusoidal period. The following algorism shows the good results for this case.

The good performance the algorism has for the possibility of the 4 sinusoids with the same nominal value, but with different amplitude variations.

And the third case covered with the algorism is when the capacitor is under the influence of wobble. The four capacitance values have neither the same nominal values nor the same amplitude variations. It is the aim to bring each pair of values measured into the same boundaries, so they have the same nominal and amplitude variation values. One pair consists of measurements made in opposite quadrants, for example, measurement values taken from quadrants 2 and 4 make one pair, measurement values taken from quadrants 1 and 3 make the second pair.

Finding the offset of each quadrant separately, the measured values without DC component are calculated. Through their ratios and ratios of amplitude variations or ratios of defined differential values of initial measurements the position angle is estimated. Because of good results for all of these non-ideal possibilities the coarse trace algorism is very robust for sensor realization.

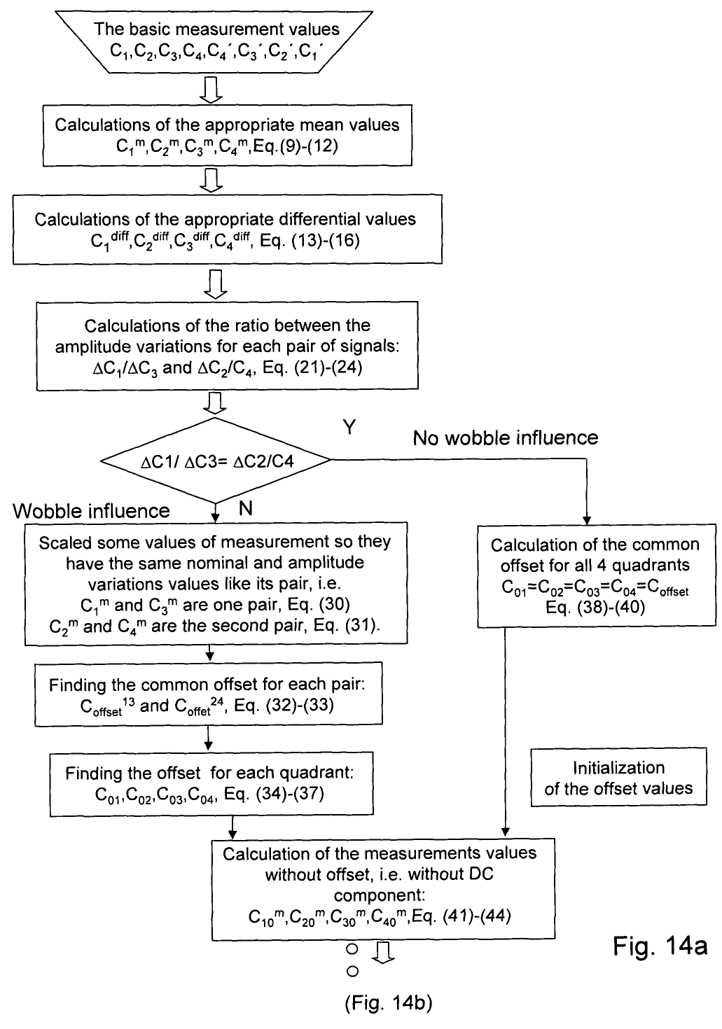

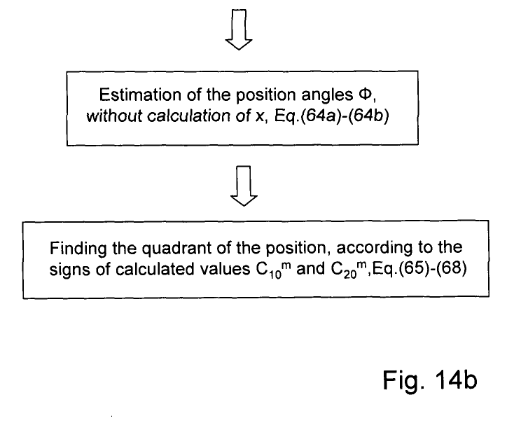

The flowchart is presented in FIG. 14. The part of the chart marked denotes the initialization step. These steps calculate the offset values for all 4 quadrants. In ideal circumstances they have to be done once only, in the beginning after the first set of measurement, or maximum a few times per certain number of packets. But from simulation results it appears that the results are better if these offset values are calculated for each measurement set. For further calculations 8 parameters calculated with equations (9) through (16) are necessary only. The calculation of offsets is different with and without wobble influence.

Knowing offset values for each quadrant separately the mean value of measurements without offset is calculated. Using these values without DC component and differential values of initial measurements the position quadrant and position angle are estimated. The x=ωTcycle parameter can be calculated and its value can be used for angle estimation purposes. Because of the very small value of x an alternative position angle estimation is developed. Because of possible smaller resolution then the calculation of x required, and because of more necessary calculations for angle estimation the alternative estimation of angle is simulated and the results are presented in the next section. This alternative case for angle estimation is suggested for realization purposes.

### Interpolation on the Set of Points Measured

In order to simulate real-time conditions with capacitances sampled at each ω*Tcycle point in time (equations (1) through (8)) interpolation has been done.

### Raw Estimated Angle

The original version of the position estimation algorism (also referenced as algorism1—FIG. 14 refers) proposed already is sensitive to irregularities in the shape of values measured.

### Conclusion on Position Estimation by Algorism 1

With mechanical tolerances and measurement results, the position estimation algorism 1ist is not precise enough. To get a more precise result the next steps were
Searching for a comprehensive calibration and correction algorism that will correct the curves.
Modify the position estimation algorism 1 to correspond with calibration and correction algorism.
Calibration and correction algorism

One of the most important advantages of the position estimation algorism 1 was that the calibration and correction process was incorporated and therefore, it was possible to do calibration and correction in real-time, i.e. instantly. The presumptions were that the deviation of the curves was limited to a few possible cases. In other words, it was known deterministically what could happen with curves measured (offset and asymmetrical amplitudes). Thus, the elimination of offset and asymmetrical amplitudes was not part of explicit algorism which would deal with it, but it was achieved in a few steps elegantly.

The results measured have shown that irregularities of capacitance curves are various and ambiguous. This requires calibration and correction which is more complex, and more calculus demanding, but it is necessary.

There are two main steps described as follows:
Calibration is a first step in the elimination of the offset and equalizing the amplitude of the curves measured. If curves measured were just translated and/or had different amplitudes, then this step would be sufficient to make them ideal. But since they are also deviated the corrective step is necessary to be carried out.
Correction completes offset elimination and equalization of amplitudes and removes the irregularities in the shape of calibrated curves.

The invention is now described on the basis of the following drawings:

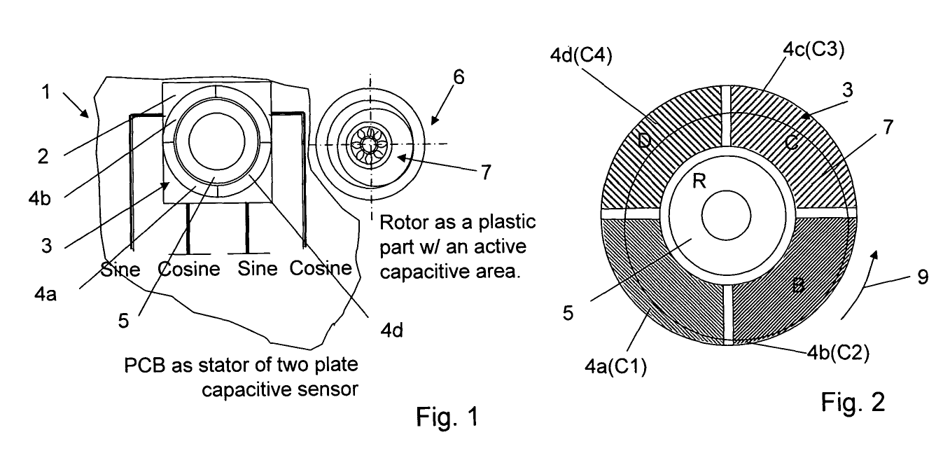

FIG. 1: basic principle of capacitive technology

FIG. 2: eccentric rotor plate covers receiver plate and partly 4 transmitters

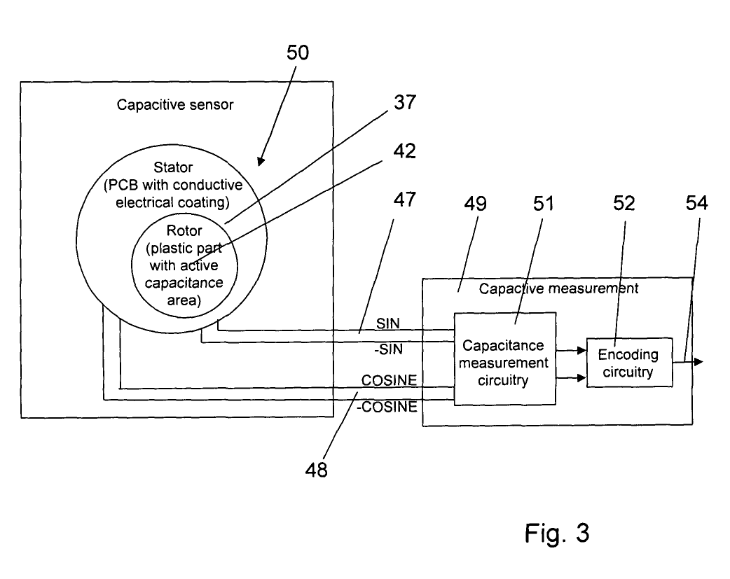

FIG. 3: block diagram of the capacitive sensor with measurement circuitry

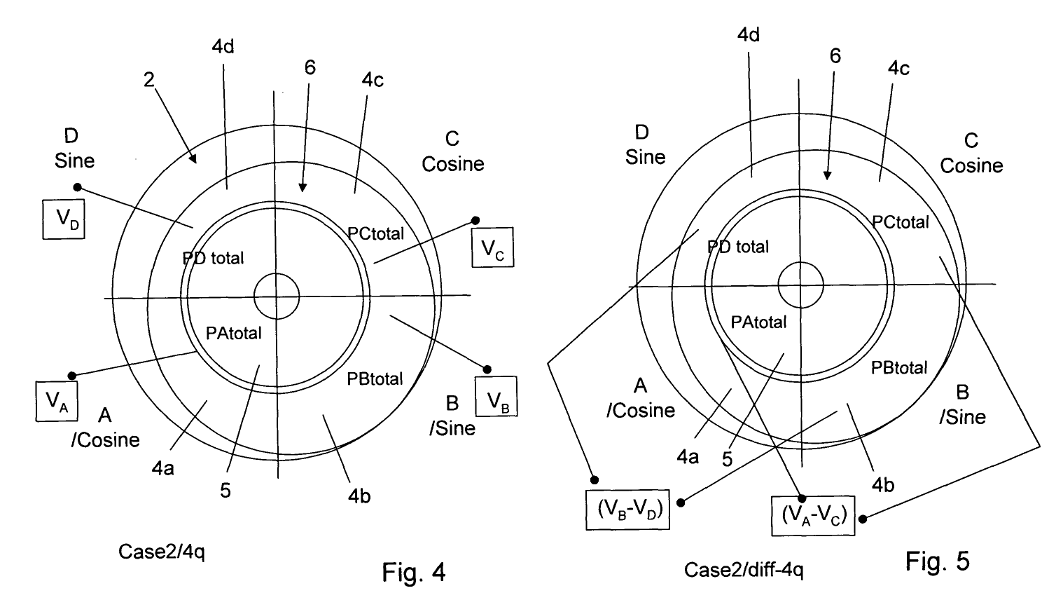

FIG. 4: single ended method of measurements in 4 quadrants with common area on stator

FIG. 5: differential method of measurements in 4 quadrants with common area on stator

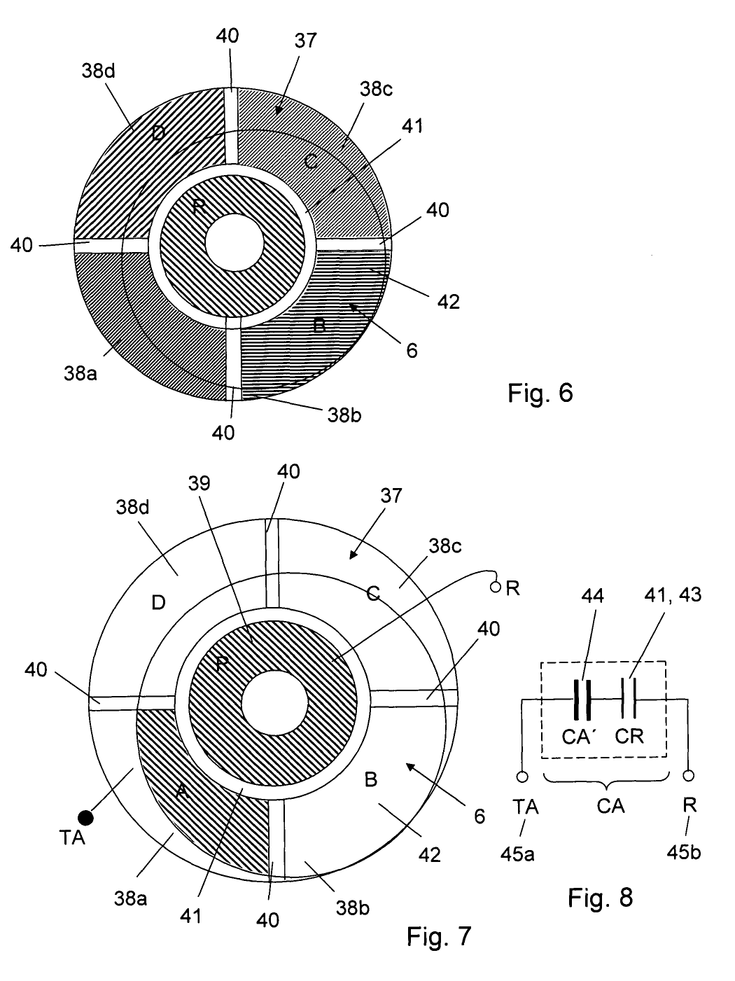

FIG. 6: two plates capacitive sensor

FIG. 7: equivalent scheme for capacitance measurements

FIG. 8: equivalent capacitances achieved with FIG. 7

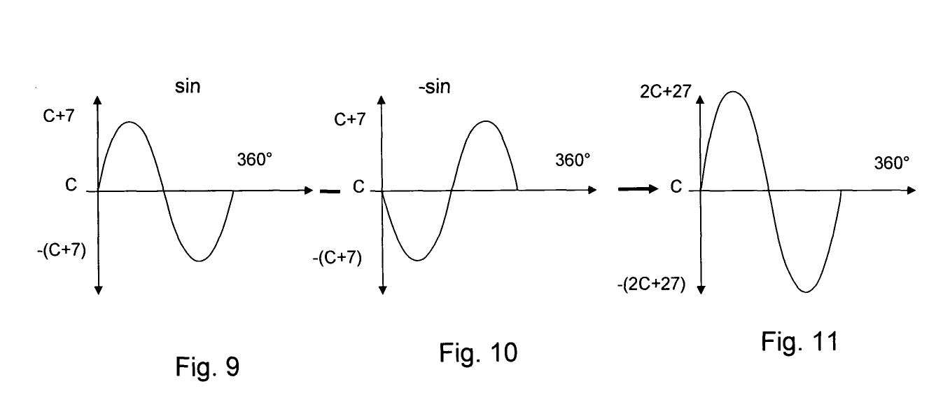

FIG. 9 through FIG. 11: addition of capacitance values to a doubled value

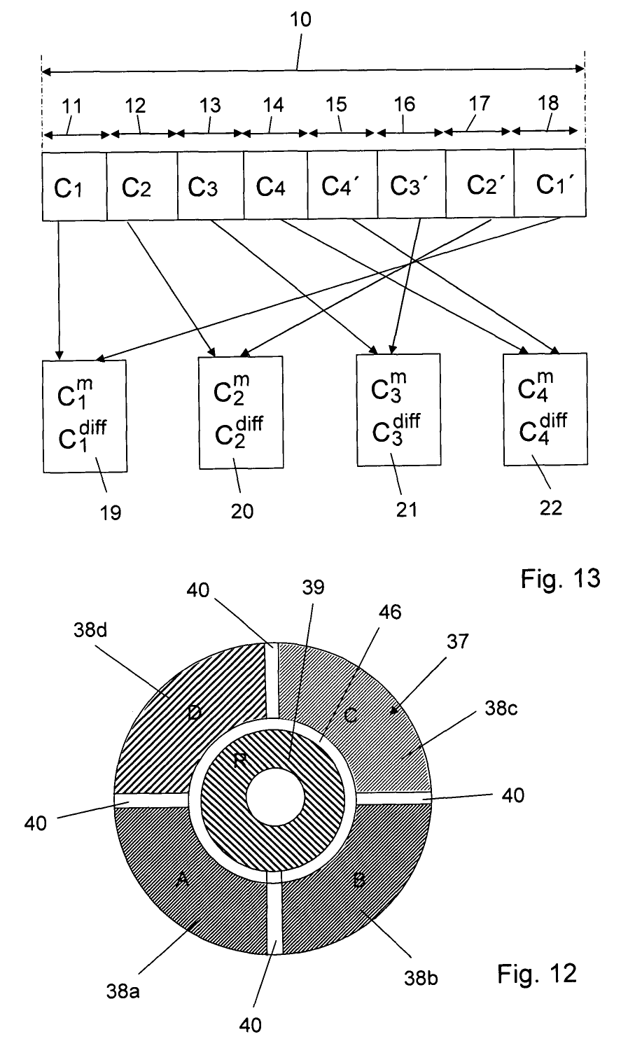

FIG. 12: stator of capacitive sensor

FIG. 13: measurements algorism overview

FIG. 14a: position estimation algorism 1 flow

FIG. 14b: end of FIG. 14a

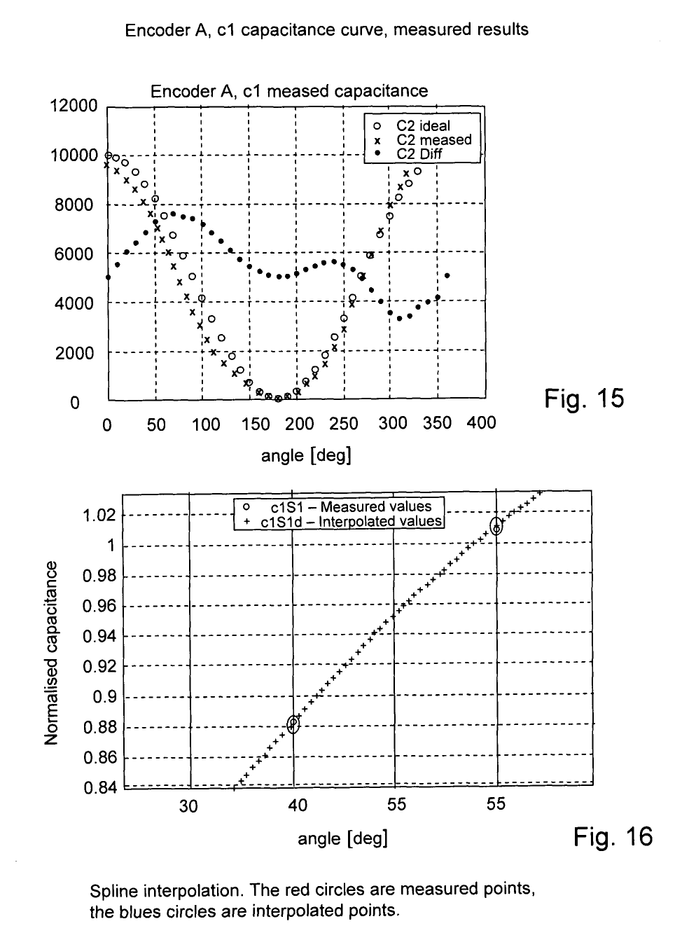

FIG. 15: encoder c1 capacitance curve, results measured

FIG. 16: spline interpolation

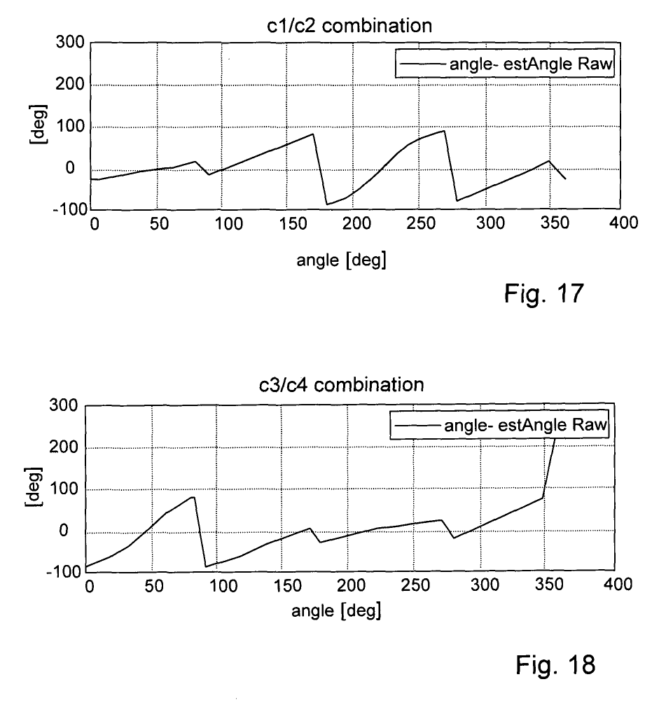

FIG. 17: algorism1 is applied on raw and scaled measurements for c1/c2 combination

FIG. 18: algorism1 is applied on raw and scaled measurements for c3/c4 combination

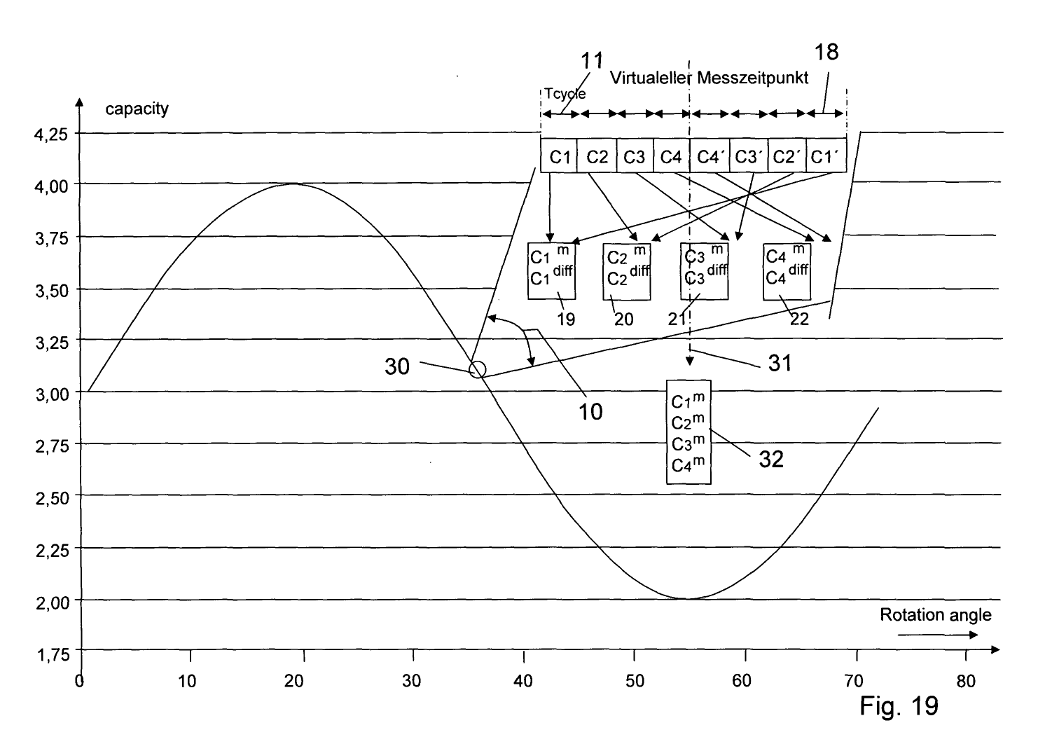

FIG. 19: determination of a mean virtual measurement point by evaluation of mean values

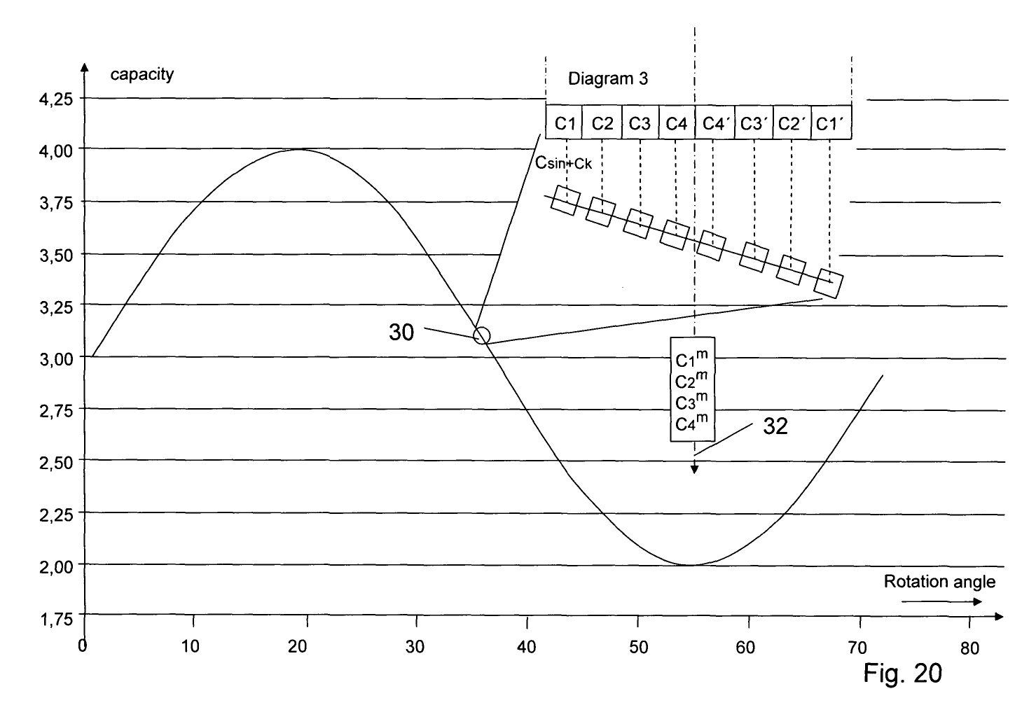

FIG. 20: determination of a mean virtual measurement point with evaluation of 4 capacitances.

A capacitive-to-analogous conversion was developed in addition to the mechanical and electrical design of the capacitive sensor.

An optional capacitive by time-to-digital conversation was developed for a SSI and BiSS interface.

FIG. 2 shows a block diagram with system architecture proposed

FIG. 3 shows a block diagram of the capacitive sensor with measurement circuitry

A capacitive sensor shall be designed with a stator-rotor arrangement to find the angular displacement. This shall be used in turn to control and position the object displaced. Stator shall be PCB with conductive electrical coatings and the rotor shall be a plastic part with a conductive capacitive area. Capacitive values varying during rotor rotation shall be measured by varying the area produced between stator and rotor. Conductive electrical coatings shall be arranged on the stator (PCB) and the rotor (pastic part) to achieve capacitive patterns required.

Conductive electrical coatings shall form one or more annular areas based on the precision required. The central annular area shall form the coarse adjustment. Detailed 4 quadrant information shall be obtained from fine adjustment coatings. These 4 waveforms (SIN, −SIN, COSINE, −COSINE) shall be used to find the actual displacement with fine precision.

FIG. 4 shows measurement of capacitance with single ended capacitors Va, Vb, Vc, Vd), where FIG. 5 shows differential measurements in 4 quadrants with Vb-Vd and Va-Vc.

If differential, SIN and −SIN shall be one pair with COS and −COS being the other which will provide a maximum dynamic range.

FIGS. 6 and 7 show assignment of rotor disk 6 and centred stator surface 37.

In accordance with FIG. 12 stator surface 37 shows electrically conductive quadrants 38a, 38b, 38c, 38d which, however, are separated from each other by radially running barriers so that four conductive coatings are insulated mutually altogether.

These quadrants 38a through 38d are separated from each other at their internal circumference by a circulating insulated insulating ferrule 46.

An electrically conductive centred stator ring 39 is arranged at the internal circumference of insulating ferrule 46, which stator ring 39 is denoted with letter R in FIG. 12. Those individual quadrants 38 are denoted with capital letters A, B, C, D.

FIGS. 4 through 7 show that the stator illustrated in FIG. 12 is overlapped by an eccentric rotor disk 6 comprising a continuous electrically conductive coating. Said eccentric rotor disk 6 shows an internal rotor ring 41 developed as a centred ring connected electrically conductive with all other eccentric areas of rotor disk 6 as a conductive coating. Therefore, it is a virtual rotor ring 41 arranged as a virtual conductive surface in the area of the entire conductive surface of said eccentric rotor disk. It is important that this virtual centred rotor ring 41 is exactly opposed to centred stator ring 39 and, in accordance with FIG. 8, forms a continuous, non-changeable capacitance CR.

This is illustrated in the replacement circuit schematic in accordance with FIG. 8. Those eccentric areas of rotor disk 6 arranged opposite to centred quadrants 38 of stator surface 37 result in a variable capacitor CA′ shown in the replacement circuit schematic in accordance with FIG. 8 so that an overall capacitance CA results from those two capacitors, i.e. CA′ and CR.

Said replacement circuit schematic according to FIG. 8 arises from each quadrant A, B, C, and D. It is a prerequisite that tapping 45 is existing for each quadrant, i.e. tappings 45a and b apply to quadrant A and centred stator ring 39.

An analogous tapping serves to derivate the capacitance value from quadrant B, and an additional tapping serves to derivate the capacitance value from quadrant C and so forth.

Therefore, rotor disk 6 is subdivided in two parts, i.e. one eccentric external area 42 and one centred internal area with rotor ring 41. This results in constant capacitor 43 illustrated in the replacement circuit schematic in accordance with FIG. 8.

In FIG. 9 a capacitance course of a quadrant on rotation of the rotor with respect to the stator is illustrated over a complete angle of rotation of 360 degrees.

FIGS. 9 and 10 show the total course according to FIG. 11. The 360 degrees modulated capacitance course is shown in FIG. 9, and FIG. 10 shows the modulated capacitance course dislocated by 180 degrees, where, for example, quadrants B and D are read out against each other to get the course shown in FIGS. 9 and 10. The summation curve in accordance with FIG. 11 results as a sum of these two values, and capacitance values are doubled by this. This results in a highly accurate read-out because doubled capacitance values can be read out much more precisely than simple capacitance values. Therefore, the evaluation circuit is simpler and more precise.

The mathematical summation of both measuring values defined in FIGS. 9 and 10 results in the summation curve in accordance with FIG. 11.

Positive and negative half cycles provide quadrant information for angle measurements.

### Capacitance Measurement and Encoding

According to FIG. 14a through 14b an algorism was developed to map the capacitance variation to actual displacement. One of the methods shall be to convert the capacitance to analogous voltage and then use TDC to get a digital equivalent. Zero crossing detectors shall also be used for precise quadrant information.

### Operating Principles

For capacitive sensors suggested the sensor comprises two plates, a stator and a rotor. The stator comprises 4 transmitter plates, one each provided in each quadrant, and 1 receiver plate provided in the centre of the stator. In FIGS. 4 through 7 the transmitter plates are denoted with A, B, C, and D and the receiver plate is denoted with R.

FIG. 12 shows the stator of the capacitive sensor. At each moment, the rotor covers the whole receiver plate area and parts of transmitter plates areas in each quadrant. The measurements algorism suggested is presented in FIG. 13. There are 8 measurements in each packet. The first capacitor C1 is measured in the course of the 1st and 8th cycle, the second capacitor C2 is measured during the 2nd and 7th cycle, the third one C3 is measured in the course of the 3rd and 6th cycle, and the fourth C4 is measured during the 4th and 5th cycle. All of these mean values are like they are measured at t=3.5 Tcycle moment, but with some amplitude modifications. These amplitude modifications cause errors between ideal and approximated values for each of all 4 capacitors.

The capacitance values are measured between two points, one is on one of transmitter plates 4, 38 and the second is on receiver plate 5. The total capacitance between them is denoted with CA, CB, CC, CD respectively for each quadrant. The total capacitance consists of serial connection of capacitance between transmitter plate and rotor and the capacitance between the rotor and receiver plate. The capacitance between the transmitter plate and rotor is proportional to the common area between these two plates, and for each quadrant it is the area of rotor which belongs to that quadrant, but without the central area which belongs to the receiver plate. The capacitance between rotor and receiver plate is always the same, and proportional to the area of the receiver overlapped by the rotor at each moment. The equivalent scheme of the measured capacitance is illustrated in FIG. 8.

In FIG. 19 the angle of rotation of the rotor in comparison with the stator is drawn on the asscissa while the signal amplitude is illustrated on the ordinate.

Hence follows that a tiny curve cut-out is overlapped with 8 measurements in the area of the entire measuring cycle so that there is a very accurate interrogation of the change of the curve.

One single point is shown on this sinusidal curve which has been enlarged to illustrate that 8 measurements of capacitances will be carried out in the course of those 8 interrogation cycles (11 through 18) in this tiny curve cut-out, where, as mentioned already, capacitances C1 through C4 are interrogated cyclically one after the other and that, in the course of a second cycle on the right hand of the virtual centred time of measurement 32, there is an inverted interrogation of capacitances, i.e. capacitance C4 will be interrogated first of all followed by an interrogation of C3, C2, and C1 then. These values are denoted with an apostrophe.

The reason for this measure is that, by symmetry of capacitance C4 to capacitance C4′ interrogated then, a virtual mean time of measurement 32 is obtained so that this results in a common mean time of measurement for all 8 capacitances measured. The differential value between C4 and C4′ results in the virtual mean time of measurement which applies also to the differential value or delta value between capacitance value C3 and C3′. This applies also to the differential value between C2 and C2′ and to the differential value between C1 and C1′.

This particular mean time of measurement 32 results in the advantage that all capacitances do have a common mean time of measurement which results in a highly accurate position determination later.

Thus, a possible mistake resulting from the curve changing continuously in the course of the entire measuring cycle is avoided.

If no virtual mean time of measurement 32 is achieved but, for example, an additional interrogation of capacitance C1 would follow an interrogation of capacitance C4, each individual capacitance value C1 through C1′ would have an own virtual mean time of measurement not desired.

The curve of the capacitance value which decreases in the course of mean time of measurement 30 (being extremely short) is illustrated greatly enlarged. It is decisive that, owing to the interrogation algorism in accordance with the invention, a mean time of measurement 32 is produced.

### DRAWING LEGEND

1 capacitive sensor
2 stator
3 PCB sensor
4 transmitter section a, b, c, d
5 receiver area
6 rotor
7 (eccentric) rotor disk
8
9 arrow
10 measuring cycle
11 interrogation cycle
12 interrogation cycle
13 interrogation cycle
14 interrogation cycle
15 interrogation cycle
16 interrogation cycle
17 interrogation cycle
18 interrogation cycle
19 combination value C1
20 combination value C2
21 combination value C3
22 combination value C4
23
24
25
26
27
28
29
30 time of measurement
31 virtual time of measurement
32 mean values (capacitances)
33
34
35
36
37 stator surface
38 quadrant a, b, c, d
39 stator ring
40 barrier
41 rotor ring
42 eccentric external area
43 constant CR capacitor
44 variable CA capacitor
45 tapping a, b
46 insulating ferrule
47 tapping line
48 tapping line
49 measuring circuit
50 capacitive sensor
51 capacitance measurement circuitry
52 encoding circuitry
53
54 output line

1. A method for the determination of a position angle of a capacitive motion encoder (1) for sensing the position of a rotor (6) relative to a stator (2, 37) comprising an eccentric rotor disk (6, 7) relatively movable to a stationary stator (2, 37) provided with n, as an integer value, electrically isolated field transmitters (4a, 4b, 4c, 4d; 38a through 38d) which generate an electrostatical field in a receiver area (5) which is dependent from a change in capacitance between stator (2, 37) and rotor disk (6, 7) in response to relative motion of the elements; and a processing circuitry (49) coupled to sense the changes in the electrostatical field and, responsive thereto, determine a measure of the position of a moving object,
characterized in that,
an entire measuring cycle is defined comprising 2n individual measurements, where each field transmitter (4a, 4b, 4c, 4d; 38a through 38d) makes one measuring value available only so that there are n measuring values existing only which, however, are measured twice, whereby a much more better capture of capacitance per total measuring cycle is gained.

2. A method according to claim 1 characterized in that, from basic measurement values C1, C2, C3, C4, C4′, C3′, C2′, C1′, calculations of appropriate mean values C1m, C2m, C3m, C4m, equations (9) through (12), are carried out and
that further calculations of appropriate differential values C1diff, C2diff, C3diff, C4diff, equations (13) through (16), are carried out
and that further calculations of the ratio between the amplitude variations for each pair of signals, i.e.
ΔC1/C3 and ΔC2/ΔC4, equations (21) through (24),
ΔC1/ΔC3=ΔC2/ΔC4, are carried out.

3. A method according to claim 2 characterized in that if there is no wobble influence calculation of the common offset for all 4 quadrants is done according to CO1=CO2=CO3=−004=Coffset, equations (38) through (40).

4. A method according to claim 3 characterized in that if there is any wobble influence some values of measurement are scaled so they have the same nominal and amplitude variations values like its pair, i.e.
C1m and C3m are one pair, equation (30),
C2m and C4m are the second pair, equation (31).
Finding the common offset for each pair:
Coffset13 and Coffset24, equations (32) through (33).

5. A method according to claim 4 characterized in that finding the offset for each quadrant:
C01, C02, C03, C04, Eq. (34)-(37)
Finding the quadrant of the position according to the signs of the calculated values C10m and C20m, equations (65) through (68)
Alternative estimation of the position angle θ,
without calculation of x, equations (64a) through (64b).

6. A method according to claim 1 characterized in that equations for single measurements C1, C2, C3, C4, C5, C6, C7 and C8 are as follows:
C₁=C₀₁+ΔC₁*sin(θ_{0F}), (1)
C₂=C₀₂+ΔC₂*cos (θ+ωT_{cycle)} (2)
C₃=C₀₃−ΔC₃*sin(θ_{0F}+2ωT_{cycle}) (3)
C₄=C₀₄−ΔC₄*cos(θ_{0F}+3ωT_{cycle}) (4)
C₄′=C₀₄−ΔC₄*cos(θ_{0F}+4ωT_{cycle}) (5)
C₃′=C₀₃−ΔC₃*sin(θ_{0F}+5ωT_{cycle}) (6)
C₂′=C₀₂ ΔC₂*cos(θ_{0F}+6ωT_{cycle}) (7)
C₁′=C₀₁+ΔC₁*sin(θ_{0F}+7ωT_{cycle}) (8)

7. A method according to claim 1 characterized in that, based on equations for single measurements C1, C2, C3, C4, C5, C6, C7 and C8 (equations (1) through (8)), differential values between the appropriate are calculated as follows:
C1m=(C1+C1′)/2 (9)
C2m=(C2+C2′)/2 (10)
C3m=(C3+C3′)/2 (11)
C4m=(C4+C4′)/2 (12)
where two pairs of them are taken from diagonal quadrants, i.e. capacitance C₁^{m} and C₃^{m} are one pair, capacitance C₂^{m} and C₄^{m} are the second pair.

8. A method according to claim 1 characterized in that,
based on the first 8 equations (1) through (8), the differential values are calculated as follows:
$$\begin{matrix}C 1 diff = ( C 1 - C {1}^{′} ) / 2 & ( 13 ) \\ = - C Δ1 * cos ( θ0 + ω3 .5 Tcycle ) * sin ( 3.5 ω Tcycle ) & ( 13 b ) \\ C 2 diff = ( C 2 - C {2}^{′} ) / 2 & ( 14 ) \\ = - C Δ2 * cos ( θ0 + ω3 .5 Tcycle ) * sin ( 2.5 ω Tcycle ) & ( 14 b ) \\ C 3 diff = ( C 3 - C {3}^{′} ) / 2 & ( 15 ) \\ = - C Δ3 * cos ( θ0 + ω3 .5 Tcycle ) * sin ( 1.5 ω Tcycle ) & ( 15 b ) \\ C 4 diff = ( C 4 - C {4}^{′} ) / 2 & ( 16 ) \\ = - C Δ4 * cos ( θ0 + ω3 .5 Tcycle ) * sin ( 0.5 ω Tcycle ) & ( 16 b )\end{matrix}$$

9. A method according to claim 2, characterized in that equations for single measurements C1, C2, C3, C4, C5, C6, C7 and C8 are as follows:
C₁=C₀₁+ΔC₁*sin(θ_{0F}), (1)
C₂=C₀₂+ΔC₂*cos (θ+ωT_{cycle)} (2)
C₃=C₀₃−ΔC₃*sin(θ_{0F}+2ωT_{cycle}) (3)
C₄=C₀₄−ΔC₄*cos(θ_{0F}+3ωT_{cycle}) (4)
C₄′=C₀₄−ΔC₄*cos(θ_{0F}+4ωT_{cycle}) (5)
C₃′=C₀₃−ΔC₃*sin(θ_{0F}+5ωT_{cycle}) (6)
C₂′=C₀₂ ΔC₂*cos(θ_{0F}+6ωT_{cycle}) (7)
C₁′=C₀₁+ΔC₁*sin(θ_{0F}+7ωT_{cycle}) (8)

10. A method according to claim 3, characterized in that equations for single measurements C1, C2, C3, C4, C5, C6, C7 and C8 are as follows:
C₁=C₀₁+ΔC₁*sin(θ_{0F}), (1)
C₂=C₀₂+ΔC₂*cos (θ+ωT_{cycle)} (2)
C₃=C₀₃−ΔC₃*sin(θ_{0F}+2ωT_{cycle}) (3)
C₄=C₀₄−ΔC₄*cos(θ_{0F}+3ωT_{cycle}) (4)
C₄′=C₀₄−ΔC₄*cos(θ_{0F}+4ωT_{cycle}) (5)
C₃′=C₀₃−ΔC₃*sin(θ_{0F}+5ωT_{cycle}) (6)
C₂′=C₀₂ ΔC₂*cos(θ_{0F}+6ωT_{cycle}) (7)
C₁′=C₀₁+ΔC₁*sin(θ_{0F}+7ωT_{cycle}) (8)

11. A method according to claim 4, characterized in that equations for single measurements C1, C2, C3, C4, C5, C6, C7 and C8 are as follows:
C₁=C₀₁+ΔC₁*sin(θ_{0F}), (1)
C₂=C₀₂+ΔC₂*cos (θ+ωT_{cycle)} (2)
C₃=C₀₃−ΔC₃*sin(θ_{0F}+2ωT_{cycle}) (3)
C₄=C₀₄−ΔC₄*cos(θ_{0F}+3ωT_{cycle}) (4)
C₄′=C₀₄−ΔC₄*cos(θ_{0F}+4ωT_{cycle}) (5)
C₃′=C₀₃−ΔC₃*sin(θ_{0F}+5ωT_{cycle}) (6)
C₂′=C₀₂ ΔC₂*cos(θ_{0F}+6ωT_{cycle}) (7)
C₁′=C₀₁+ΔC₁*sin(θ_{0F}+7ωT_{cycle}) (8)

12. A method according to claim 5, characterized in that equations for single measurements C1, C2, C3, C4, C5, C6, C7 and C8 are as follows:
C₁=C₀₁+ΔC₁*sin(θ_{0F}), (1)
C₂=C₀₂+ΔC₂*cos (θ+ωT_{cycle)} (2)
C₃=C₀₃−ΔC₃*sin(θ_{0F}+2ωT_{cycle}) (3)
C₄=C₀₄−ΔC₄*cos(θ_{0F}+3ωT_{cycle}) (4)
C₄′=C₀₄−ΔC₄*cos(θ_{0F}+4ωT_{cycle}) (5)
C₃′=C₀₃−ΔC₃*sin(θ_{0F}+5ωT_{cycle}) (6)
C₂′=C₀₂ ΔC₂*cos(θ_{0F}+6ωT_{cycle}) (7)
C₁′=C₀₁+ΔC₁*sin(θ_{0F}+7ωT_{cycle}) (8)

13. new A method according to claim 2 characterized in that, based on equations for single measurements C1, C2, C3, C4, C5, C6, C7 and C8 (equations (1) through (8)), differential values between the appropriate are calculated as follows:
C1m=(C1+C1′)/2 (9)
C2m=(C2+C2′)/2 (10)
C3m=(C3+C3′)/2 (11)
C4m=(C4+C4′)/2 (12)
where two pairs of them are taken from diagonal quadrants, i.e. capacitance C₁^{m} and C₃^{m} are one pair, capacitance C₂^{m} and C₄^{m} are the second pair.

14. new A method according to claim 3 characterized in that, based on equations for single measurements C1, C2, C3, C4, C5, C6, C7 and C8 (equations (1) through (8)), differential values between the appropriate are calculated as follows:
C1m=(C1+C1′)/2 (9)
C2m=(C2+C2′)/2 (10)
C3m=(C3+C3′)/2 (11)
C4m=(C4+C4′)/2 (12)
where two pairs of them are taken from diagonal quadrants, i.e. capacitance C₁^{m} and C₃^{m} are one pair, capacitance C₂^{m} and C₄^{m} are the second pair.

15. new A method according to claim 4 characterized in that, based on equations for single measurements C1, C2, C3, C4, C5, C6, C7 and C8 (equations (1) through (8)), differential values between the appropriate are calculated as follows:
C1m=(C1+C1′)/2 (9)
C2m=(C2+C2′)/2 (10)
C3m=(C3+C3′)/2 (11)
C4m=(C4+C4′)/2 (12)
where two pairs of them are taken from diagonal quadrants, i.e. capacitance C₁^{m} and C₃^{m} are one pair, capacitance C₂^{m} and C₄^{m} are the second pair.

16. new A method according to claim 5 characterized in that, based on equations for single measurements C1, C2, C3, C4, C5, C6, C7 and C8 (equations (1) through (8)), differential values between the appropriate are calculated as follows:
C1m=(C1+C1′)/2 (9)
C2m=(C2+C2′)/2 (10)
C3m=(C3+C3′)/2 (11)
C4m=(C4+C4′)/2 (12)
where two pairs of them are taken from diagonal quadrants, i.e. capacitance C₁^{m} and C₃^{m} are one pair, capacitance C₂^{m} and C₄^{m} are the second pair.

17. new A method according to claim 6 characterized in that, based on equations for single measurements C1, C2, C3, C4, C5, C6, C7 and C8 (equations (1) through (8)), differential values between the appropriate are calculated as follows:
C1m=(C1+C1′)/2 (9)
C2m=(C2+C2′)/2 (10)
C3m=(C3+C3′)/2 (11)
C4m=(C4+C4′)/2 (12)
where two pairs of them are taken from diagonal quadrants, i.e. capacitance C₁^{m} and C₃^{m} are one pair, capacitance C₂^{m} and C₄^{m} are the second pair.

18. A method according to claim 2 characterized in that,
based on the first 8 equations (1) through (8), the differential values are calculated as follows:
$$\begin{matrix}C 1 diff = ( C 1 - C {1}^{′} ) / 2 & ( 13 ) \\ = - C Δ1 * cos ( θ0 + ω3 .5 Tcycle ) * sin ( 3.5 ω Tcycle ) & ( 13 b ) \\ C 2 diff = ( C 2 - C {2}^{′} ) / 2 & ( 14 ) \\ = - C Δ2 * cos ( θ0 + ω3 .5 Tcycle ) * sin ( 2.5 ω Tcycle ) & ( 14 b ) \\ C 3 diff = ( C 3 - C {3}^{′} ) / 2 & ( 15 ) \\ = - C Δ3 * cos ( θ0 + ω3 .5 Tcycle ) * sin ( 1.5 ω Tcycle ) & ( 15 b ) \\ C 4 diff = ( C 4 - C {4}^{′} ) / 2 & ( 16 ) \\ = - C Δ4 * cos ( θ0 + ω3 .5 Tcycle ) * sin ( 0.5 ω Tcycle ) & ( 16 b )\end{matrix}$$

19. A method according to claim 3 characterized in that,
based on the first 8 equations (1) through (8), the differential values are calculated as follows:
$$\begin{matrix}C 1 diff = ( C 1 - C {1}^{′} ) / 2 & ( 13 ) \\ = - C Δ1 * cos ( θ0 + ω3 .5 Tcycle ) * sin ( 3.5 ω Tcycle ) & ( 13 b ) \\ C 2 diff = ( C 2 - C {2}^{′} ) / 2 & ( 14 ) \\ = - C Δ2 * cos ( θ0 + ω3 .5 Tcycle ) * sin ( 2.5 ω Tcycle ) & ( 14 b ) \\ C 3 diff = ( C 3 - C {3}^{′} ) / 2 & ( 15 ) \\ = - C Δ3 * cos ( θ0 + ω3 .5 Tcycle ) * sin ( 1.5 ω Tcycle ) & ( 15 b ) \\ C 4 diff = ( C 4 - C {4}^{′} ) / 2 & ( 16 ) \\ = - C Δ4 * cos ( θ0 + ω3 .5 Tcycle ) * sin ( 0.5 ω Tcycle ) & ( 16 b )\end{matrix}$$

20. A method according to claim 4 characterized in that,
based on the first 8 equations (1) through (8), the differential values are calculated as follows:
$$\begin{matrix}C 1 diff = ( C 1 - C {1}^{′} ) / 2 & ( 13 ) \\ = - C Δ1 * cos ( θ0 + ω3 .5 Tcycle ) * sin ( 3.5 ω Tcycle ) & ( 13 b ) \\ C 2 diff = ( C 2 - C {2}^{′} ) / 2 & ( 14 ) \\ = - C Δ2 * cos ( θ0 + ω3 .5 Tcycle ) * sin ( 2.5 ω Tcycle ) & ( 14 b ) \\ C 3 diff = ( C 3 - C {3}^{′} ) / 2 & ( 15 ) \\ = - C Δ3 * cos ( θ0 + ω3 .5 Tcycle ) * sin ( 1.5 ω Tcycle ) & ( 15 b ) \\ C 4 diff = ( C 4 - C {4}^{′} ) / 2 & ( 16 ) \\ = - C Δ4 * cos ( θ0 + ω3 .5 Tcycle ) * sin ( 0.5 ω Tcycle ) & ( 16 b )\end{matrix}$$
